(19) United States
(12) Patent Application Publication
(10) Pub. No.: US 2019/0258302 A1
(43) Pub. Date: Aug. 22, 2019

(54) POWER SUPPLY MODULE

(71) Applicant: TAIYO YUDEN CO., LTD., Tokyo (JP)

(72) Inventor: Yutaka AOKI, Tokyo (JP)

(73) Assignee: TAIYO YUDEN CO., LTD., Tokyo (JP)

(21) Appl. No.: 16/279,845

(22) Filed: Feb. 19, 2019

(30) Foreign Application Priority Data
Feb. 19, 2018 (JP) 2018-026918

(51) Int. Cl. G06F 1/26; C08G 73/10; H01M 4/60

(52) U.S. Cl. CPC G06F 1/263; H01M 4/602; C08G 73/10

(57) ABSTRACT

A power supply module includes: a first resin substrate including a first electrode formed on one surface of a first polyimide substrate; a second resin substrate including a second electrode formed on one surface of a second polyimide substrate, the second resin substrate arranged such that the first and second electrodes oppose to each other; a first switching element provided between the first and second electrodes, and coupled to the first electrode; a second switching element provided between the first and second electrodes, and coupled to the second electrode; and a chip component provided between the first and second electrodes, the chip component having one end coupled to the first electrode at a position different from a region where the first switching element is arranged, and another end coupled to the second electrode at a position different from a region where the second switching element is arranged.

### CROSS-REFERENCE TO RELATED APPLICATION

The present application claims priority pursuant to 35 U.S.C. § 119(a) from Japanese patent application number 2018-26918, filed on Feb. 19, 2018, the entire disclosure of which is hereby incorporated by reference herein.

### BACKGROUND

### Technical Field

The present disclosure relates to a power supply module.

### Description of the Related Art

There is a power supply module which includes a snubber circuit, for example (see, for example, WO2016/076121).

A power supply module having a circuit configuration as illustrated in FIG. 5 includes a snubber circuit for absorbing high voltage transients caused when a switch in the circuit is turned off. The snubber circuit includes, for example, a chip component, and lead electrodes electrically coupling the chip component to power supply terminals. In the power supply module, as each lead electrode becomes longer, the inductance of the lead electrode becomes larger. Due to this increase in the inductance, the power supply module may become large in whole circuit size and less efficient.

### SUMMARY

A power supply module according to the present disclosure includes: a first resin substrate including a first electrode formed on one surface of a first polyimide substrate; a second resin substrate including a second electrode formed on one surface of a second polyimide substrate, the second resin substrate being arranged such that the first electrode and the second electrode oppose to each other; a first switching element provided between the first electrode and the second electrode, and coupled to the first electrode; a second switching element provided between the first electrode and the second electrode, and coupled to the second electrode; and a chip component provided between the first electrode and the second electrode, the chip component having one end coupled to the first electrode at a position different from a region where the first switching element is arranged, and another end coupled to the second electrode at a position different from a region where the second switching element is arranged.

### BRIEF DESCRIPTION OF THE DRAWINGS

FIG. 1A is a cross-sectional diagram of a power supply module according to an embodiment of the present disclosure;

FIG. 1B is a circuit diagram of a power supply module according to an embodiment of the present disclosure;

FIGS. 2A to 2D are diagrams for explaining switching elements employed for a power supply module;

FIGS. 3A to 3D are diagrams for explaining a method of manufacturing a power supply module;

FIGS. 4A to 4C are diagrams for explaining a method of manufacturing a power supply module;

FIG. 5 is a circuit diagram of a power supply module;

FIG. 6 is a side view illustrating a power supply module according to an embodiment of the present disclosure;

FIG. 7 is a perspective view illustrating a power supply module according to an embodiment of the present disclosure;

FIG. 8 is a plan view illustrating a power supply module according to an embodiment of the present disclosure;

FIG. 9 is a cross-sectional diagram schematically illustrating a power supply module according to an embodiment of the present disclosure;

FIG. 10 is a perspective view illustrating a capacitor with lead frame in a power supply module according to an embodiment of the present disclosure; and

FIG. 11 is a cross-sectional diagram schematically illustrating a power supply module according to an embodiment of the present disclosure.

### DETAILED DESCRIPTION

A power supply module according to an embodiment of the present disclosure will be described with reference to the drawings as appropriate.

### <Power Supply Module 100 According to Embodiment of the Present Disclosure>

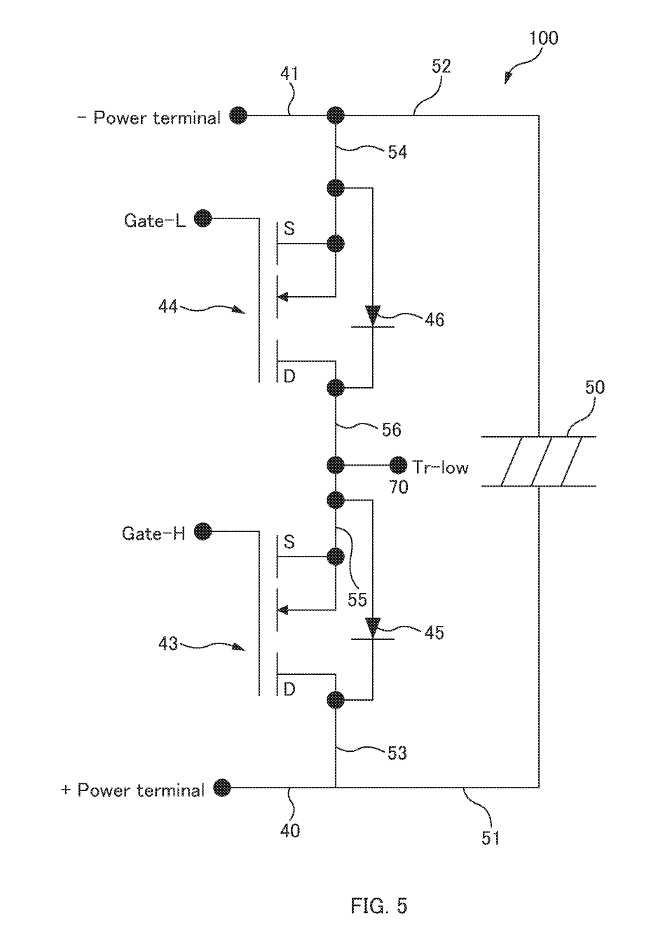

A power supply module 100 is a module for converting an inputted voltage or current into a desired voltage or current. As illustrated in FIG. 5, the power supply module 100 includes: a pair of field-effect transistors (MOSFETs) 43, 44 coupled together in series configured to perform their switching operations, respectively; a diode 45 coupled to the source and drain electrodes of the MOSFET 43; a diode 46 coupled to the source and drain electrodes of the MOSFET 44; a lead wiring 56 provided to the drain electrode of the MOSFET 44 on the low side; and a lead wiring 55 provided to the source electrode on the high side. In addition, a capacitor 50 is provided between lead wiring 40 and 41. The capacitor 50 absorbs high voltage transients caused when the switches open/close, for example. An example of the capacitor 50 includes a snubber capacitor. Note that in the case where the power supply module employs a printed circuit board or a ceramic board, the lead wiring 40, 41 is mainly Cu wiring, and includes a lead when it is attached to the MOSFET.

In such a power supply module 100, as the length of lead wiring coupling a MOSFET and a chip component becomes longer, the inductance of the lead wiring becomes larger. As the inductance of the lead wiring becomes larger, the risk of damage caused by surge voltage increases. Accordingly, the power supply module 100 needs to have a higher breakdown voltage. Conversely, the length of the lead wiring needs to be shortened in order to reduce the size of the power supply module 100. Furthermore, in a case where the chip component is a chip capacitor, the chip capacitor is a ceramic chip capacitor. In this case, if the substrate on which the chip component is mounted is made of ceramic or metal, the difference in coefficient α of thermal expansion between the chip component and the substrate causes cracking and/or the like in a coupling portion between the chip component and an electrode. Such a phenomenon a cracking occurs similarly in an epoxy resin-based printed circuit board and the like. Moreover, when the chip component is coupled to the substrate with solder or Ag paste, cracking may occur in the solder or Ag paste.

The present disclosure relates to the “power supply module.” As can be understood from the title of the disclosure, the power supply module employs a switching element which is commonly referred to as a “power element,” and heat generated by large current flowing therethrough raises the temperature of the power supply module to a considerably high temperature. In other words, repeated cycles of low and high temperatures, whose difference is large, cause cracking in the coupling portion, and furthermore in the semiconductor chip itself.

Examples of the power element include a bipolar transistor (BipTr), a power metal oxide semiconductor (MOS) transistor, and an insulated-gate bipolar transistor (IGBT). Furthermore, examples of the material of the power element include Si, GaN, GaAs, SiC, diamond, and the like, and such a switching element generates high heat.

The present disclosure focuses on a polyimide resin having heat resistance and flexibility. The power supply module according to the present disclosure has a structure in which two polyimide substrates sandwich the power element. The length of lead wiring is shortened by direct coupling of the power element to electrodes through opening parts in the polyimide substrates. Furthermore, the power supply module according to an embodiment of the present disclosure is characterized in that even though the chip component is sandwiched between the polyimide substrates, the flexibility of the polyimide substrates eases stresses of the chip component and the polyimide substrates, thereby making it possible to suppress cracking in the coupling portion.

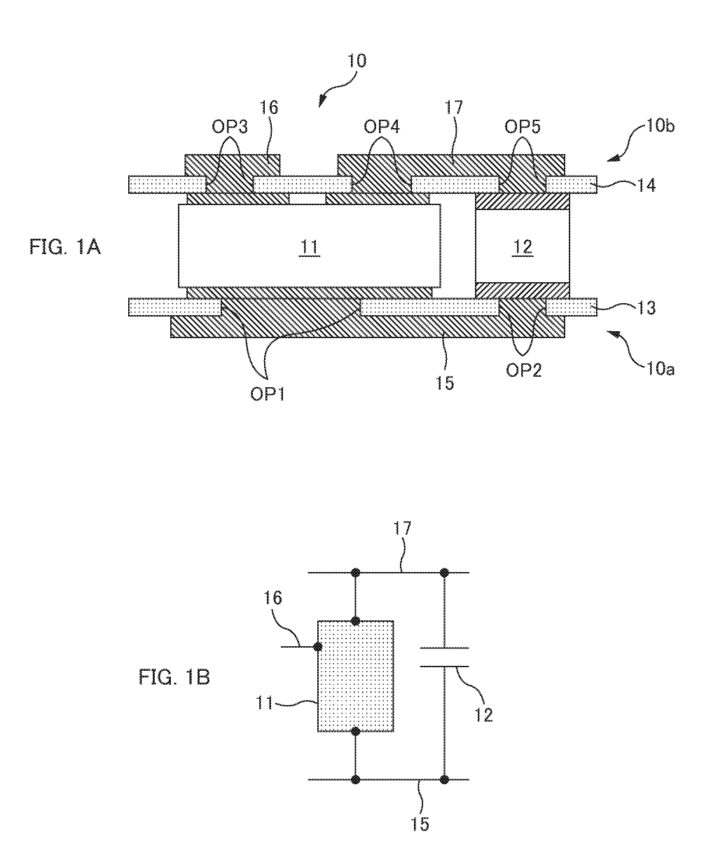

FIG. 1A is a diagram of the power supply module 10 for explaining a summary of an embodiment of the present disclosure. FIG. 1B is an equivalent circuit diagram of the power supply module 10. A circuit element 11 and a chip component 12 are sandwiched between two polyimide substrates 13, 14. Electrodes 15 to 17 are formed through opening parts OP1 to OP5 provided in the polyimide substrates 13, 14. The circuit element 11 is coupled to the electrode 15 through the opening part OP1, and to the electrode 16 through the opening part OP3. This makes it possible to use no metal fine wire, thereby shortening the wiring length. Here, the chip component 12 is, for example, one of a multilayer ceramic capacitor, a film capacitor, a Zener diode, an inductor, a resistor and the like. In an embodiment of the present disclosure, the chip component 12 may be a rectangular parallelepiped-shaped multilayer ceramic capacitor made of a ceramic material, and furthermore may be a so-called LW reversal type multilayer ceramic capacitor in which external electrodes are arranged along two longitudinal ends thereof, respectively. In the case where the LW reversal type multilayer ceramic capacitor is used, a current path as the capacitor is shortened and the area of the electrode itself increases, thereby being able to reduce the parasitic inductance. Accordingly, it is effective to employ the LW reversal type multilayer ceramic capacitor as the chip component 12 of the power supply module 10. The flexibility of the polyimide substrates enables the chip component 12, which is the multilayer ceramic capacitor, to maintain the reliability of the electrode connection. Note that a substrate formed of the polyimide substrate 13 and the electrode 15 will be referred to as a “first resin substrate 10a,” while a substrate formed of the polyimide substrate 14 and the electrodes 16, 17 will be referred to as a “second resin substrate 10b.”

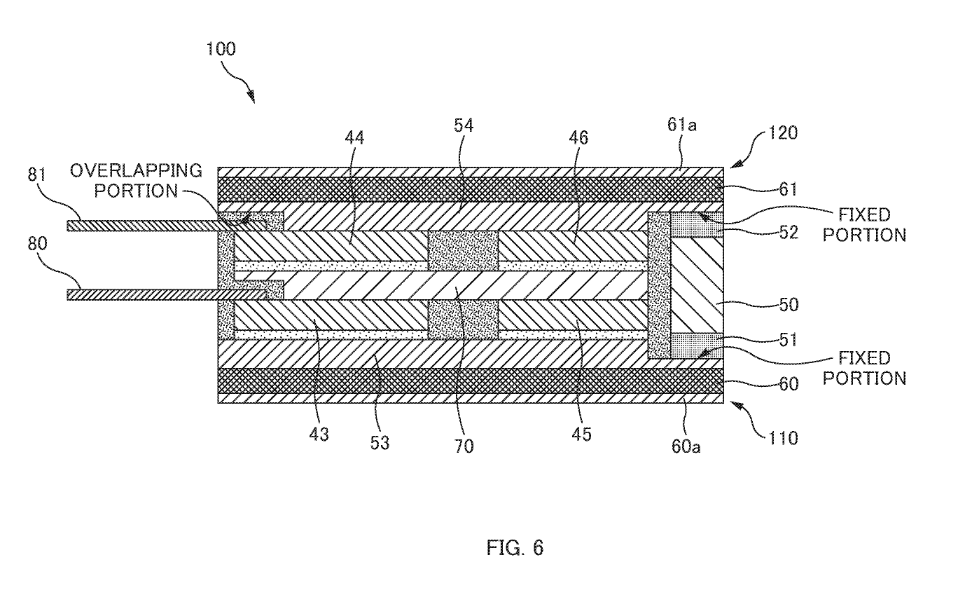

Although will be described with reference to FIG. 6, the power supply module 100 illustrated in FIG. 1 may have a configuration in which: the electrodes are formed on the upper surface of the lower polyimide substrate and the back surface of the upper polyimide substrate; and the circuit element 11 and the chip component 12 are coupled to the electrodes. In this case, the circuit element 11 and the chip component 12 are coupled to the electrodes by solder or conductive paste. Furthermore, although will be described with reference to FIG. 6, in the electrodes formed on the upper surface of the polyimide substrate 13 and the back surface of the polyimide substrate 14, portions thereof corresponding to the chip component 12 are thinner than other portions thereof. This makes it possible to ease the thermal expansion coefficient α.

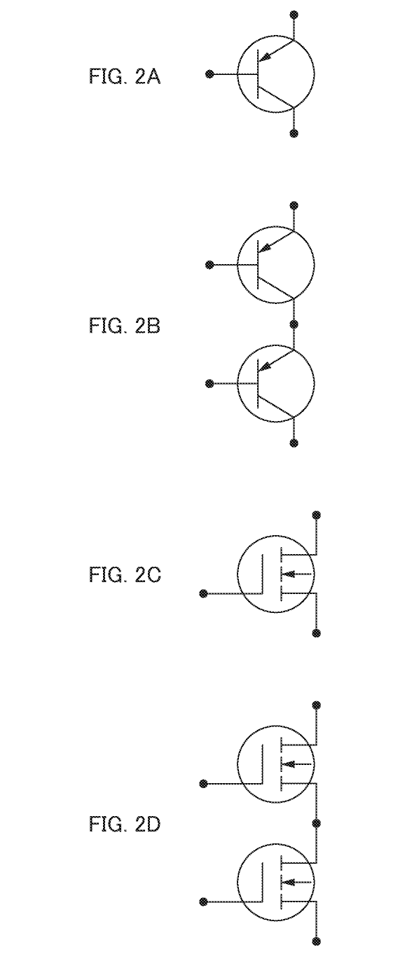

FIGS. 2A to 2D are diagrams illustrating examples of the circuit element 11 which include, for example, the single power element or multiple power elements coupled in series corresponding to the aforementioned power element(s). FIG. 2A illustrates an example where the circuit element 11 includes a single bipolar transistor, while FIG. 2B illustrates an example where the circuit element 11 includes two bipolar transistors. FIG. 2C illustrates an example where the circuit element 11 includes a single field effect transistor, while FIG. 2D illustrates an example where the circuit element 11 includes two field effect transistors. Other examples may include a single or multiple power integrated circuits or the like.

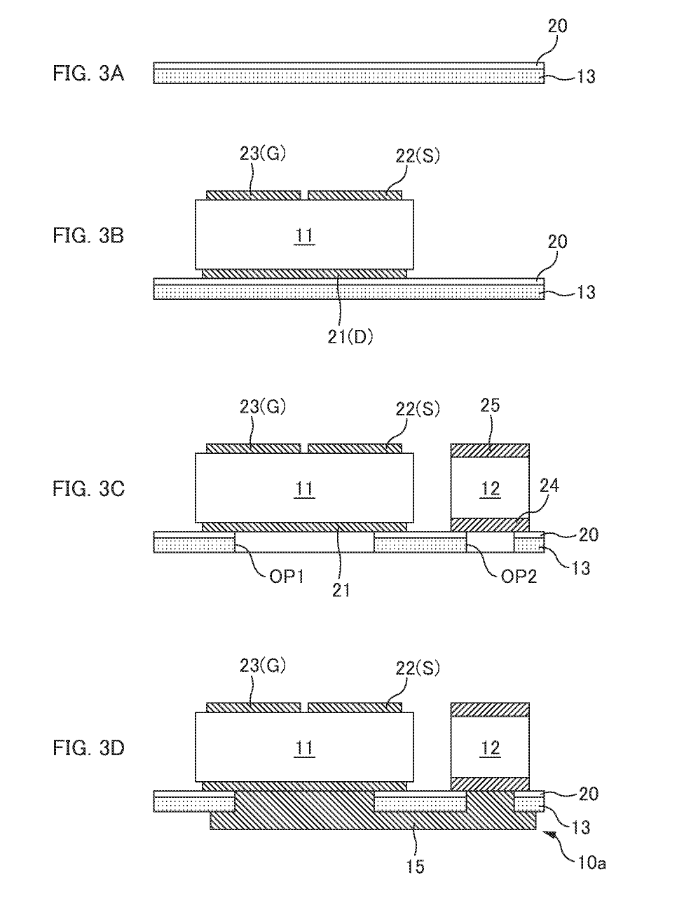

Next, a method of manufacturing the power supply module will be briefly described. To begin with, as illustrated in FIG. 3A, the polyimide substrate 13 is prepared. The front surface of the polyimide substrate 13 is covered with an adhesive 20. In addition, since the polyimide material has flexibility, a ring-shaped metal frame is used to keep the polyimide substrate 13 flat.

Subsequently, as illustrated in FIG. 3B, the power element 11 is provided on the substrate 13. Here, the lower electrode serves as a drain electrode 21, while the upper electrodes serve as a source electrode 22 and a gate electrode 23, respectively. After that, the chip component 12 is mounted on the polyimide substrate 13.

Thereafter, as illustrated in FIG. 3C, the opening parts OP1, OP2 are formed in the polyimide substrate 13. A portion of the polyimide substrate 13 and the adhesive 20 which corresponds to the drain electrode 21 is removed using a laser. Thus, the drain electrode 21 is exposed. Furthermore, a portion of the polyimide substrate 13 and the adhesive 20 which corresponds to the electrode 24 of the chip component 12 is removed to form the opening part OP2.

Subsequently, as illustrated in FIG. 3D, the electrode 15 is formed in the opening parts OP1, OP2 by plating, sputtering or chemical vapor deposition (CVD). Accordingly, the first resin substrate 10a is formed.

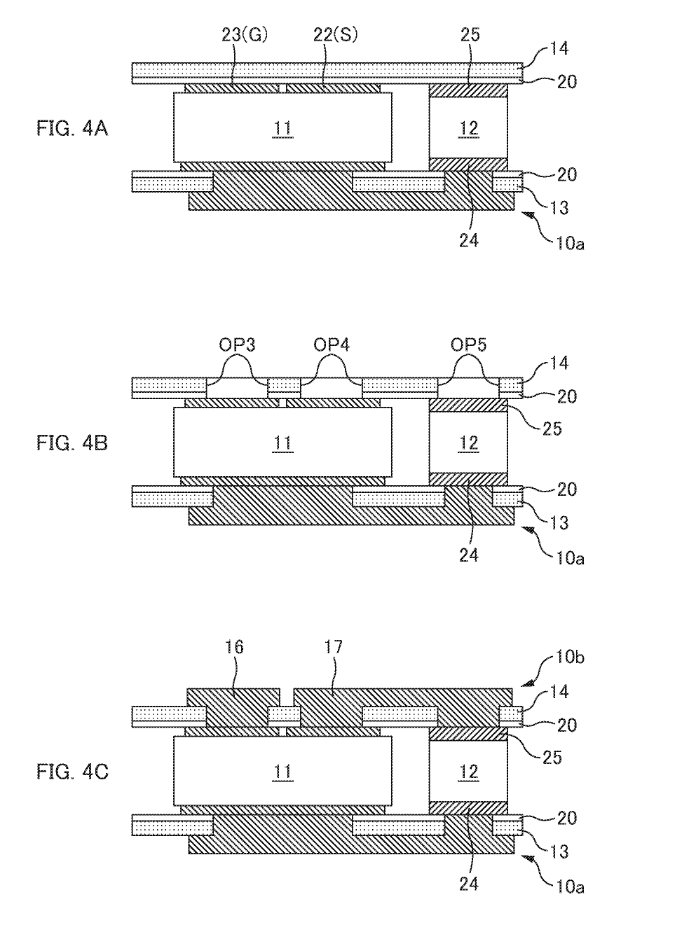

After that, as illustrated in FIG. 4A, the polyimide substrate 14 is arranged on the power element 11 and the chip component 12. Here, also, the entirety of one surface of the polyimide substrate 14 is covered with the adhesive 20 to fix the polyimide substrate 14.

Thereafter, as illustrated in FIG. 4B, the opening parts OP3 to OP5 are formed in the polyimide substrate 14. The gate electrode 23, the source electrode 22, and the electrode 25 of the chip component 12 are exposed through the opening parts OP3, OP4, and OP5, respectively.

Finally, as illustrated in FIG. 4C, the gate electrode 16 and the source electrode 17 are formed by plating. Here, plating may be selectively applied, or may be applied to the entire surface and then subjected to patterning. Accordingly, the second resin substrate 10b is formed.

As can be understood from the above explanation, the electrodes are formed directly on the top and bottom of the power element 11 and the chip component 12 instead of being coupled thereto using metal fine wires, and thus the wiring length can be reduced to a large extent. In addition, since the chip component 12 is fixed to the flexible substrates 13, 14, cracking and the like in the electrodes can be suppressed. Note that a resin may be provided between the substrates 13, 14 and sealed.

Subsequently, a power supply module 100 illustrated in FIGS. 5 and 6 will be described. The power supply module 100 is such a power supply module that the aforementioned lead wiring is shortened as much as possible by: coupling the two MOSFETs 43, 44 together in series; and coupling the snubber capacitor 50 is coupled to the two ends of the series-coupled MOSFETs 43, 44. Note that, in the drawings, their upper sides represent the front sides of the substrates and the switching elements, while their lower sides represent the back sides of the substrates and the switching elements.

To begin with, a circuit diagram will be described. The wiring 40 is coupled to a plus power supply terminal, while the wiring 41 is coupled to a minus power supply terminal. The drain electrode of a first switching element (for example, a MOSFET) 43 is electrically coupled to the wiring 40, while the source electrode of a second switching element (for example, a MOSFET) 44 is electrically coupled to the wiring 41. Furthermore, the source electrode of the first switching element 43 and the drain electrode of the second switching element 44 are coupled to each other. A terminal 70 extends from the wiring which couples the source electrode of the first switching element 43 and the drain electrode of the second switching element 44.

Further, a first diode 45 is provided, with its cathode and anode electrodes being respectively coupled to the drain and source electrodes of the first switching element 43. A second diode 46 is provided, with its cathode and anode electrodes being respectively coupled to the drain and source electrodes of the second switching element 44. Furthermore, the gate electrodes of the first and second switching elements 43, 44 are coupled to a gate-H terminal and a gate-L terminal, respectively. Moreover, the snubber capacitor 50 is coupled between the plus power supply terminal and the minus power supply terminal.

A line 40 joining the plus power supply terminal and the first switching element corresponds to lead wiring. A line 51 joining the plus power supply terminal and the snubber capacitor 50 corresponds to lead wiring. A line 41 joining the minus power supply terminal and the second switching element corresponds to lead wiring. A line 52 joining the minus power supply terminal and the snubber capacitor 50 corresponds to lead wiring. Lines 55, 56 between the source electrode of the first switching element 43 and the drain electrode of the second switching element 44 correspond to lead wiring.

Next, a cross-sectional diagram of the power supply module 100 will be described with reference to FIG. 6.

First, polyimide substrates 60, 61, which are features of the present disclosure, are included. The entire front surface of the first polyimide substrate 60 is covered with a first electrode 53. A heat-dissipation metal film 60a is provided on the entire back surface of the first polyimide substrate 60. The drain electrode of the first switching element 43 is electrically coupled to the left side of the first electrode 53, while the cathode electrode of the first diode 45 is electrically coupled to the right side of the first electrode 53. The drain electrode of the first switching element 43 and the cathode electrode of the first diode 45 are fixed to the left and right sides of the first electrode 53, respectively, with solder or Ag paste. Note that a substrate constituted by the first polyimide substrate 60, the first electrode 53, and the metal film 60a will be referred to as a “first resin substrate 110.”

Further, a second electrode 54 is provided on the back surface of the second polyimide substrate 61, while a heat-dissipation metal film 61a is provided on the front surface of the second polyimide substrate 61. The source electrode of the second switching element 44 is fixed to the lower left of the second electrode 54, while the anode electrode of the second diode 46 is provided on the lower right of the second electrode 54. An intermediate electrode 70 is provided between the source electrode of the first switching element 43 and the drain electrode of the second switching element 44, as well as between the anode electrode of the first diode 45 and the cathode electrode of the second diode 46. Note that a substrate constituted by the second polyimide substrate 61, the second electrode 54, and the metal film 61a will be referred to as a “second resin substrate 120.”

The right end of the first electrode 53 is a region in which an electrode 51 of the chip component 50 is provided, and this region is formed thinner than other region of the first electrode 53. The right end of the second electrode 54 is a region in which an electrode 52 of the chip component 50 is provided, and this region is similarly formed thinner than other region of the second electrode 54. The thinner regions in which the electrodes are provided are to solve the difference in the thermal expansion coefficient α. Furthermore, the flexibility is increased by reducing the thickness of the metals. This makes it possible to suppress cracking in the coupling portions of the chip component 50.

Further, the gate electrode is located in the left end of the first switching element 43, and a gate lead 80 extends outward from the gate electrode. The intermediate electrode 70 is formed thinner in a portion thereof corresponding to where the gate lead 80 extends from the gate electrode of the first switching element 43. This portion ensures that a space between the intermediate electrode 70 and the first switching element 43, particularly the gate electrode thereof, is thicker than the thickness of the lead, thereby preventing the lead from coming into contact with the intermediate electrode 70.

On the other hand, the gate electrode is located in the left end of the second switching element 44, and a gate lead 81 extends outward from the gate electrode. The second electrode 54 is formed thinner in a portion thereof corresponding to where the gate lead 81 extends from the gate electrode of the second switching element 44. This portion ensures that a space between the second electrode 54 and the second switching element 44, particularly the gate electrode thereof, is thicker than the thickness of the lead, thereby preventing the lead from coming into contact with the second electrode 54.

Finally, as described above, the chip component 50 is provided between the first electrode 53 and the second electrode 54, particularly between the portion of the first electrode 53 which is thinner in film thickness than other portion of the first electrode 53 and the portion of the second electrode 54 which is thinner in film thickness than other portion of the second electrode 54. The chip component 50 is bonded with solder, conductive paste, such as Ag paste, or the like. These bonding agents are likely to cause bad connection due to cracking and/or the like. However, by forming the electrode thin, the flexibility of each polyimide substrate inclusive of the corresponding electrode is easily secured, thereby being able to suppress bad connection in the chip component.

The first and second polyimide substrates 60, 61 may be electrically fixed to the first and second electrodes 53, 54 with Cu plating, respectively, by: providing opening parts in portions thereof corresponding to the electrodes of the switching elements 43, 44 and portions thereof corresponding to the electrodes 51, 52 of the chip component 50. Furthermore, the interstice between the first polyimide substrate 60 and the second polyimide substrate 61 may be sealed with insulating resin.

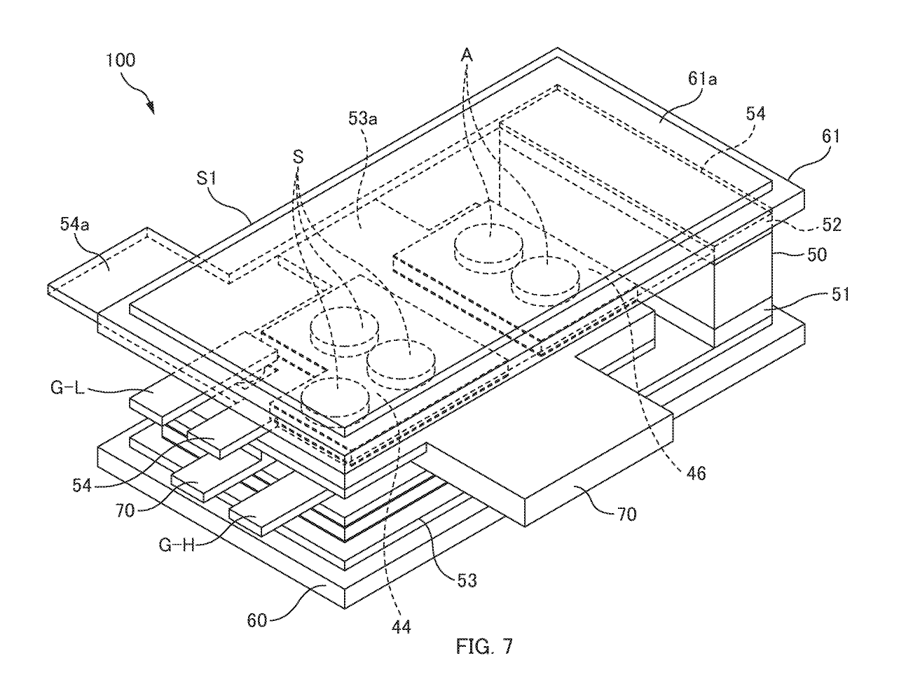

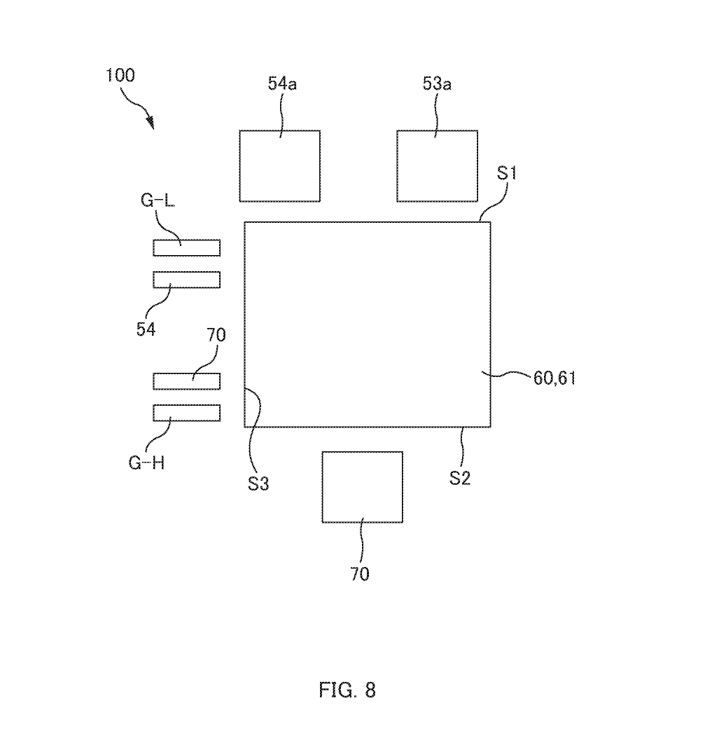

Next, the external appearance of the power supply module 100 as viewed from the above will be briefly described again with reference to FIGS. 7 and 8. Reference numeral 61 denotes the rectangular second polyimide substrate. In FIG. 7, the heat-dissipation metal film 61a is provided on the front surface of the second polyimide substrate 61, where the heat-dissipating metal film 61a is slightly smaller than the second polyimide substrate 61. This area is, for example, an area where a heat dissipation fin is to be attached. Note that the same applies to the metal film 60a as well. The second electrode 54 is provided on and covers the back surface of the second polyimide substrate 61, where the second electrode 54 is slightly smaller than the second polyimide substrate 61. A lead plate 54a serving as the minus power supply terminal extends outward from a left portion of an upper long side S1 of the second polyimide substrate 61. Further, the first electrode 53 covers the front surface of the first polyimide substrate 60, where the first electrode 53 is slightly smaller than the first polyimide substrate 60. A lead plate 53a serving as the plus power supply terminal extends outward from the right portion of the upper long side S1 of the first polyimide substrate 60.

Three circular portions represent the source electrode S of the second switching element 44, while two circular portions represent the anode electrode A of the second diode 46. The source electrode S of the second switching element 44 and the anode electrode A of the second diode 46 are coupled to the second electrode 54. The intermediate electrode 70 provided thereunder extends from a lower long side S2 of the second polyimide substrate 61 toward the obliquely lower left side.

Meanwhile, reference sign G-L denotes the lead coupled to the gate electrode of the second switching element 44. The lead extends outward from a left short side S3 of the second polyimide substrate 61.

Reference numeral 60 denotes the first polyimide substrate provided thereunder. The first electrode 53 covers the front surface of the first polyimide substrate 60, where the first electrode 53 is slightly smaller than the first polyimide substrate 60. As explained with reference to FIG. 6, the first switching element 43 and the first diode 45 are provided between the first electrode 53 and the intermediate electrode 70, and are electrically coupled to each other. The arrangement and shapes of the first switching element 43 and the first diode 45 are the same as those of the second switching element 44 and the second diode 46. Note that reference sign G-H denotes the gate lead coupled to the gate electrode of the first switching element 43.

Finally, the chip component 50 will be described. The chip component 50 is formed in a rectangular parallelepiped shape. The electrode 52 is provided on the upper surface and the four side surfaces of the chip component 50, inclusive of their corner portions, while the electrode 51 is provided on the lower surface and the four side surfaces of the chip component 50, inclusive of their corner portions. Note that the electrodes 51, 52 provided on the four side surfaces are away from each other, and the electrical insulation is thus secured. Furthermore, the electrodes 51, 52 are electrically coupled to the first and second electrodes 53, 54, respectively.

### <Power Supply Modules According to Other Embodiments>

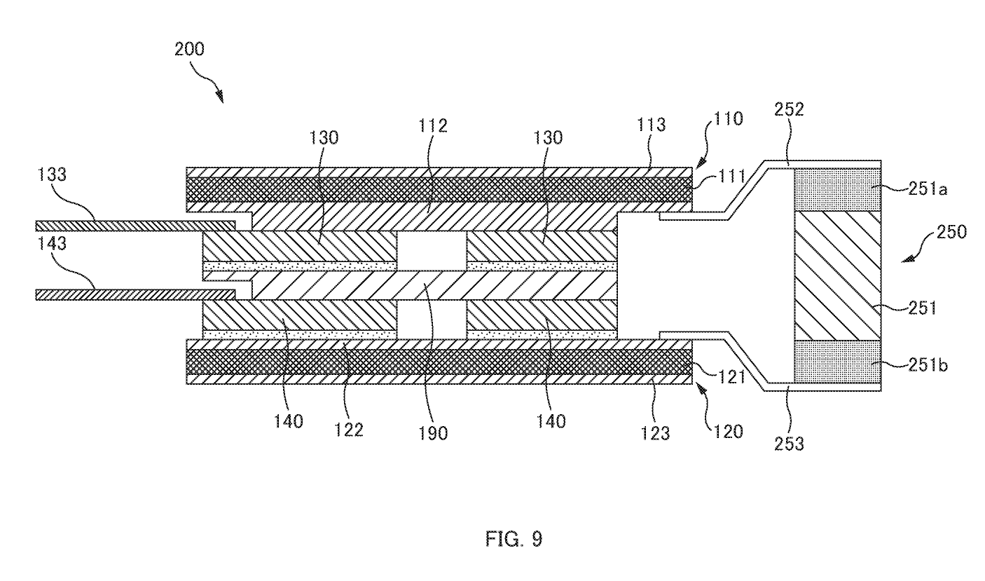

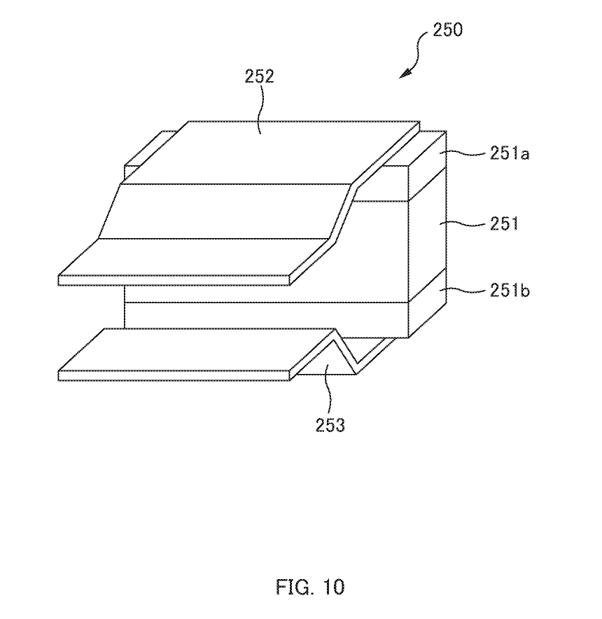

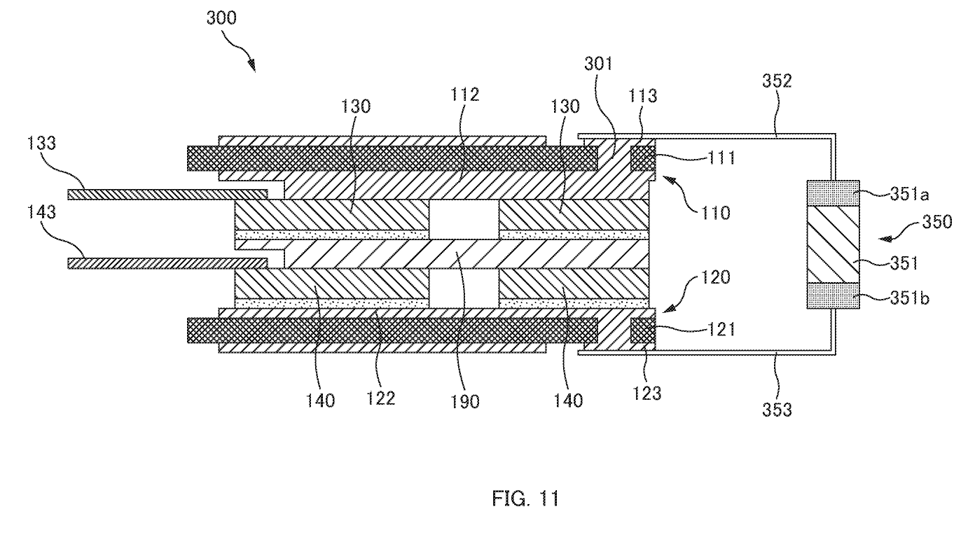

Power supply modules according to other embodiments will be described hereinafter with reference to FIGS. 9, 10, and 11. FIG. 9 is a cross-sectional diagram schematically illustrating a power supply module 200. FIG. 10 is a perspective diagram schematically illustrating a capacitor with lead frames. FIG. 11 is a cross-sectional diagram schematically illustrating a power supply module 300 according to another embodiment.

As illustrated in FIG. 9, an electronic component 250 attached to the power supply module 200 includes: a chip component 251 which is a snubber capacitor; a first lead electrode 252 having one end connected to one end portion of the chip component 251, and the other end connected to a first electrode 112; and a second lead electrode 253 having one end connected to the other end portion of the chip component 251, and the other end connected to a second electrode 122. The first lead electrode 252 is coupled to the chip component 251 and the first electrode 112, as well as the second lead electrode 253 is coupled to the chip component 251 and the second electrode 122, for example, with solder.

The electronic component 250 will be described more specifically. In a state where the electronic component 250 is coupled to the first electrode 112, the first lead electrode 252 is formed to extend substantially horizontally from an electrode end part 251a of the chip component 251 and be inclined downward toward the first electrode 112. Similarly, the second lead electrode 253 is formed to extend substantially horizontally from the other electrode end part 251b of the chip component 251 and be inclined upward toward the second electrode 122. Accordingly, even if thermal denaturation or the like causes minute changes to the first and second resin substrate 110, 120, the first and second lead electrodes 252, 253 bend according to the thermal denaturation, thereby being able to suppress cracking in the solder.

Furthermore, as illustrated in FIG. 10, the first and second lead electrodes 252, 253 are each formed with a wide surface. This can decrease the inductances of the respective first and second lead electrodes 252, 253. Moreover, it is preferable that the first and second lead electrodes 252, 253 have elastic forces in a direction toward the first and second electrodes 112, 122. This can suppress cracking in the solder. Further, with a clearance between the leads 252 and 253 being set larger than that between the electrodes 112 and 122, the leads 252, 253 are under tension to push against the electrodes 112, 122, respectively, such that the leads 252, 253 can be temporarily fixed.

As illustrated in FIG. 11, an electronic component 350 in the power supply module 300 includes: a chip component 351; a third lead electrode 352 having one end connected to one electrode end part 351a of the chip component 351 and the other end connected to a third electrode 113; and a fourth lead electrode 353 having one end connected to the other electrode end part 351b of the chip component 351 and the other end connected to a fourth electrode 123. The third lead electrode 352 is coupled to the chip component 351 and the third electrode 113, as well as the fourth lead electrode 353 is coupled to the chip component 351 and the fourth electrode 123, for example, with solder. Furthermore, the third lead electrode 352 is coupled to the first electrode 112 through a via hole 301, while the fourth lead electrode 353 is coupled to the second electrode 122 through a via hole 301.

Such an electronic component 350 is used, for example, in a case where the chip member 351 cannot be arranged to be directly sandwiched between the first and second resin substrates 110, 120, a case where the first and second resin substrates 110, 120 are not provided with the first and second polyimide substrates 111, 121, respectively so that the chip member 351 cannot be arranged to be directly sandwiched between the first and second resin substrates 110, 120, or other case. The third lead electrode 352 is formed to extend outward from the electrode end part 351a of the chip component 351, while the fourth lead electrode 353 is formed to extend outward from the other electrode end part 351b of the chip component 351. Accordingly, even if thermal denaturation or the like causes minute changes to the first and second resin substrate 110, 120, the third and fourth lead electrodes 352, 353 bend according to the thermal denaturation, thereby being able to suppress cracking in the solder.

Although embodiments of the present disclosure have been described, the present disclosure is not limited to these embodiments. The materials, shapes and arrangements of the above-described components are merely for the embodiments for carrying out the present disclosure, and may be variously changed within the scope not departing from the gist of the disclosure.

For example, in FIG. 1 (FIG. 6), two or more chip components 12 (50) may be prepared and mounted such that the chip components 12 (50) in a state of being coupled together in parallel are sandwiched between the polyimide substrate 13 (60) and the polyimide substrate 14 (61). For example, in a case where the chip components 12 (50) are capacitors (including multilayer ceramic capacitors), the frequency range becomes wider with respect to the electrostatic capacitance, thereby being able to obtain excellent electrical characteristics.

What is claimed is:

1. A power supply module comprising:
a first resin substrate made of a polyimide resin;
a second resin substrate made of a polyimide resin, and arranged to oppose the first resin substrate;
a switching element provided between the first resin substrate and the second resin substrate; and
a chip component provided between the first resin substrate and the second resin substrate,
the switching element and the chip component are coupled to electrodes that are provided through opening parts formed in the first resin substrate and the second resin substrate.

2. The power supply module according to claim 1, wherein
the electrodes are formed by plating.

3. The power supply module according to claim 1, wherein
the chip component is a multilayer ceramic capacitor of a rectangular parallelepiped shape.

4. The power supply module according to claim 3, wherein
the multilayer ceramic capacitor having external electrodes arranged along two longitudinal ends thereof.

5. A power supply module comprising:
a first resin substrate including a first electrode formed on one surface of a first polyimide substrate;
a second resin substrate including a second electrode formed on one surface of a second polyimide substrate, the second resin substrate being arranged such that the first electrode and the second electrode oppose to each other;
a first switching element provided between the first electrode and the second electrode, and coupled to the first electrode;
a second switching element provided between the first electrode and the second electrode, and coupled to the second electrode; and
a chip component provided between the first electrode and the second electrode,
the chip component having
one end coupled to the first electrode at a position different from a region where the first switching element is arranged, and
another end coupled to the second electrode at a position different from a region where the second switching element is arranged.

6. The power supply module according to claim 5, wherein
the chip component is fixed in a space between the first resin substrate and the second resin substrate.

7. The power supply module according to claim 6, wherein
the first and second electrodes each are thinner in a portion thereof to which the chip component is fixed than in other portion thereof.

8. The power supply module according to claim 5, wherein
the first polyimide substrate and the second polyimide substrate each are formed in a sheet shape with a thickness of 10 μm to 50 μm, and
the first electrode and the second electrode each are formed with a thickness of 10 μm to 50 μm.

9. The power supply module according to claim 5, wherein
a plurality of the chip components are arranged in parallel between ends on one side and ends on another side of the first electrode and the second electrode.

10. The power supply module according to claim 5, wherein
the chip component is at least one of a chip capacitor, a chip resistor, a chip solenoid, and a leadless multilayer ceramic capacitor.

11. The power supply module according to claim 5, further comprising:
a metal electrode of a plate-shape or a thin layer, the metal electrode being provided between the first switching element and the second switching element, and electrically coupled to the first switching element and the second switching element, the first switching element being provided closer to the first electrode than the second switching element is.

12. The power supply module according to claim 5, further comprising:
an insulating resin sealing the first switching element and the second switching element between the first resin substrate and the second resin substrate.

13. The power supply module according to claim 5, wherein
the chip component includes a chip, a first lead electrode, and a second lead electrode,
the first lead electrode has
one end coupled to one end portion of the chip component, and
another end coupled to the first electrode, and
the second lead electrode has
one end coupled to another end portion of the chip component, and
another end coupled to the second electrode.

14. The power supply module according to claim 5, further comprising:
a third electrode formed on another surface of the first polyimide substrate; and
a fourth electrode formed on another surface of the second polyimide substrate, wherein
the chip component includes a chip, a third lead electrode, and a fourth lead electrode,
the third lead electrode has
one end coupled to one end portion of the chip component, and
another end coupled to the third electrode, and
the fourth lead electrode has
one end coupled to another end portion of the chip component, and
another end coupled to the fourth electrode.

15. The power supply module according to claim 5, further comprising:
a first power supply terminal coupled to the first electrode, and configured to supply a first voltage;
a second power supply terminal coupled to the second electrode, and configured to supply a second voltage lower than the first voltage; and
an intermediate electrode arranged between the first power supply terminal and the second power supply terminal, wherein
the first switching element includes
a first electrode coupled to the first electrode,
a second electrode coupled to the intermediate electrode, and
a first control electrode configured to control currents flowing through the first and second electrodes, respectively, and
the second switching element includes
a third electrode coupled to the second electrode,
a fourth electrode coupled to the intermediate electrode, and
a second control electrode configured to control currents flowing through the third and fourth electrodes, respectively.
